(19) United States
(12) Patent Application Publication
(10) Pub. No.: US 2026/0228051 A1
(43) Pub. Date: Aug. 6, 2026

(54) TASK EXECUTION METHOD AND APPARATUS, STORAGE MEDIUM AND ELECTRONIC DEVICE

(71) Applicant: ZHEJIANG LAB, Hangzhou, Zhejiang (CN)

(72) Inventors: Lingfang ZENG, Hangzhou, Zhejiang (CN); Zhiguang CHEN, Hangzhou, Zhejiang (CN); Wen CHENG, Hangzhou, Zhejiang (CN); Yong LI, Hangzhou, Zhejiang (CN); Guang CHEN, Hangzhou, Zhejiang (CN)

(73) Assignee: ZHEJIANG LAB, Hangzhou, Zhejiang (CN)

(21) Appl. No.: 19/150,891

(22) PCT Filed: Jun. 30, 2023
(86) PCT No.: PCT/CN2023/105037

§ 371 Date: Jul. 24, 2025

(30) Foreign Application Priority Data
Mar. 29, 2023 (CN) 202310345473.4

(51) Int. Cl. G06F 9/50

(52) U.S. Cl. CPC G06F 9/5044; G06F 9/5038

(57) ABSTRACT

Task execution methods and apparatuses, storage media and electronic devices are provided. The task execution method includes: determining a computing task corresponding to each of network layers in the target model, determining device information corresponding to a plurality of computing devices participating in a calculation of the target model; for each of the network layers, determining computing time required for executing a computing task corresponding to the network layer by the plurality of computing devices; determining a target device corresponding to the network layer according to at least one of the computing time, data transmission time between a computing device corresponding to a previous network layer and other computing devices, memory space required by data of the network layer or remaining memory of each of the computing devices, and executing the computing task by the target device after receiving an execution request of the computing task.

### CROSS-REFERENCE TO RELATED APPLICATION

The present application is a U.S. National Stage of International Application No. PCT/CN2023/105037, filed on Jun. 30, 2023, which claims the benefit of priority to Chinese Application 202310345473.4, filed on Mar. 29, 2023, the entire contents of which are incorporated herein by reference for all purposes.

### TECHNICAL FIELD

The present disclosure relates to the field of computer technologies, and in particular to, task execution methods, apparatuses, storage media and electronic devices.

### BACKGROUND

With the development of deep neural network technology, some super-large deep neural network models emerge gradually, which brings many challenges to a computing system for training these models due to very large number of parameters of these modules. Large-scale training not only requires more computing resources, but also requires high resources such as device memory and transmission, so a parallel training of models has gradually become a mainstream development trend.

At present, a model is usually divided into multiple computing tasks and assigned to different graphic processing units (GPUs) to perform calculations, while one or more central processing units (CPUs) are only responsible for data transmission and scheduling, such an approach needs to rely on a large number of GPU computing resources, but CPU computing resources are not effectively utilized, which will not only waste resources in a model training process, but also further increase training cost of the model by deploying more GPUs to perform the computing tasks.

Therefore, how to improve the utilization rate of different types of devices and reduce the training cost of the model is an urgent problem to be solved.

### SUMMARY

The present disclosure provides task execution methods and apparatuses, storage media and electronic devices, so as to solve the above problems existing in the prior art.

The present disclosure adopts the following technical solution.

The present disclosure provides a task execution method, which includes the following steps:
acquiring model data of a target model;
parsing the model data, determining a computing task corresponding to each of network layers in the target model, and determining device information corresponding to a plurality of computing devices participating in a calculation of the target model, where the computing device includes at least one central processing unit CPU and at least one graphic processing unit GPU;
for each of the network layers, determining computing time required for executing a computing task corresponding to the network layer by the plurality of computing devices according to a number of calculations involved in executing the computing task corresponding to the network layer and the device information corresponding to the plurality of computing devices;
for each of the network layers, determining a computing device executing the computing task corresponding to the network layer as a target device corresponding to the network layer according to at least one of the computing time, data transmission time between a computing device executing a computing task corresponding to a previous network layer and other computing devices, memory space required by data of the network layer or remaining memory of the plurality of computing devices, where the data transmission time is determined according to an amount of data outputted by the previous network layer and transmission information between the computing device executing the computing task corresponding to the previous network layer and the other computing devices; and
deploying the computing task corresponding to each of the network layers in the target model in a target device corresponding to each of the network layers, so as to execute the computing task by the target device after receiving an execution request of the computing task corresponding to each of the network layers.

In some examples, before the determining the computing device corresponding to the network layer, the method further includes:
determining at least one execution unit in each of the plurality of computing devices to obtain a plurality of execution units; and
determining computing power corresponding to each of the plurality of execution units according to the device information corresponding to the plurality of computing devices.

In some examples, for each of the network layers, the determining computing time required for executing the computing task corresponding to the network layer by the plurality of computing devices according to the number of calculations involved in executing the computing task corresponding to the network layer and the device information corresponding to the plurality of computing devices includes:
for each of the network layers, determining computing time required for executing the computing task corresponding to the network layer by each of the execution units according to the number of calculations involved in executing the computing task corresponding to the network layer and the computing power corresponding to each of the execution units.

In some examples, the determining the computing device executing the computing task corresponding to the network layer as the target device corresponding to the network layer according to at least one of the computing time, the data transmission time between the computing device executing the computing task corresponding to the previous network layer and the other computing devices, the memory space required by the data of the network layer or the remaining memory of the plurality of computing devices includes:
determining an execution unit executing the computing task corresponding to the network layer as a target execution unit corresponding to the network layer according to at least one of the computing time corresponding to each of the execution units, data transmission time between a reference execution unit and other execution units, the memory space or the remaining memory, where the reference execution unit includes an execution unit executing the computing task corresponding to the previous network layer; and
where the deploying the computing task corresponding to each of the network layers in the target model in the target device corresponding to each of the network layers, so as to execute the computing task by the target device after receiving the execution request of the computing task corresponding to each of the network layers includes:
deploying the computing task corresponding to each of the network layers in a target device where a target execution unit corresponding to each of the network layers is located, so as to execute the computing task by the target execution unit after receiving the execution request of the computing task corresponding to each of the network layers.

In some examples, the data transmission time is determined according to transmission information between the reference execution unit and other execution units and the amount of data outputted by the previous network layer.

In some examples, the determining the execution unit executing the computing task corresponding to the network layer as the target execution unit corresponding to the network layer according to at least one of the computing time corresponding to each of the execution units, the data transmission time between the reference execution unit and the other execution units, the memory space or the remaining memory includes:
in response to determining that the network layer is not an initial network layer of the target model, for each of the execution units, determining comprehensive time corresponding to the execution unit according to computing time corresponding to the execution unit and data transmission time corresponding to the execution unit;
determining one or more candidate execution units among the plurality of execution units, where each of the candidate execution units is an execution unit where remaining memory of a corresponding computing device is larger than the memory space, and corresponding comprehensive time is less than required computing time when executing the computing task corresponding to the network layer by the reference execution unit; and
determining the target execution unit corresponding to the network layer according to comprehensive time corresponding to each of the candidate execution units.

In some examples, the determining the execution unit executing the computing task corresponding to the network layer as the target execution unit corresponding to the network layer according to at least one of the computing time corresponding to each of the execution units, the data transmission time between the reference execution unit and the other execution units, the memory space or the remaining memory includes:
in response to determining that the network layer is an initial network layer of the target model, determining one or more candidate execution units;
determining computing time corresponding to each of the candidate execution units according to the number of calculations involved in executing the computing task corresponding to the network layer and computing power corresponding to each of the candidate execution units; and
determining the target execution unit corresponding to the network layer according to the computing time corresponding to each of the candidate execution units.

In some examples, the determining the one or more candidate execution units includes:
determining one or more execution units with remaining memory larger than the memory space as the one or more candidate execution units.

In some examples, the method further includes:
for each of the network layers, in response to determining that at least two transmission modes exist between the target execution unit corresponding to the network layer and a target execution unit corresponding to an adjacent network layer of the network layer, monitoring a transmission state of a current transmission mode;
determining whether the current transmission mode is to be adjusted according to the transmission state; and
in response to determining that the current transmission mode is to be adjusted, adjusting the current transmission mode to another transmission mode.

In some examples, the method further includes: determining transmission modes among the plurality of execution units and a bandwidth corresponding to each of the transmission modes, where the transmission mode includes: at least one of a first transmission mode or a second transmission mode.

In some examples, the method further includes:
in response to determining that the target execution unit corresponding to the network layer and a target execution unit corresponding to an adjacent network layer are related to the GPU, and the second transmission mode exists between the target execution unit corresponding to the network layer and the target execution unit corresponding to the adjacent network layer, transmitting data between the network layer and the adjacent network layer by the second transmission mode, or in response to determining that the target execution unit corresponding to the network layer and a target execution unit corresponding to an adjacent network layer are not related to the GPU, or the second transmission mode does not exist between the target execution unit corresponding to the network layer and the target execution unit corresponding to the adjacent network layer, transmitting the data between the network layer and the adjacent network layer by the first transmission mode.

In some examples, the first transmission mode includes a PCI-e, and the second transmission mode includes an NVLINK.

The present disclosure provides a task execution apparatus, including:
an acquiring module, configured to acquire model data of a target model;
a parsing module, configured to parse the model data, determine a computing task corresponding to each of network layers in the target model, and determine device information corresponding to a plurality of computing devices participating in a calculation of the target model, where the computing device includes at least one central processing unit (CPU) and at least one graphic processing unit (GPU);
a first determining module, configured to: for each of the network layers, determine computing time required for executing a computing task corresponding to the network layer by the plurality of computing devices according to a number of calculations involved in executing the computing task corresponding to the network layer and the device information corresponding to the plurality of computing devices;
a second determining module, configured to: for each of the network layers, determine a computing device executing the computing task corresponding to the network layer as a target device corresponding to the network layer according to at least one of the computing time, data transmission time between a computing device executing a computing task corresponding to a previous network layer and other computing devices, memory space required by data of the network layer or remaining memory of the plurality of computing devices, where the data transmission time is determined according to an amount of data outputted by the previous network layer and transmission information between the computing device executing the computing task corresponding to the previous network layer and the other computing devices;
an execution module, configured to deploy the computing task corresponding to each of the network layers in the target model in a target device corresponding to each of the network layers, so as to execute the computing task by the target device after receiving an execution request of the computing task corresponding to each of the network layers.

The present disclosure provides a computer-readable storage medium, where a computer program is stored in the storage medium, and the computer program, when executed by a processor, realizes the above task execution method.

The present disclosure provides an electronic device, including a memory, a processor and a computer program stored in the memory and capable of running on the processor, when the processor executes the program, the above task execution method is realized.

At least one technical solution adopted in the present disclosure can achieve the following beneficial effects:

The task execution method provided in the present disclosure includes: determining a computing task corresponding to each of network layers in the target model, and device information corresponding to a plurality of computing devices participating in a target model calculation; for each of the network layers, determining computing time required for executing the computing task corresponding to the network layer by the plurality of computing devices according to a number of calculations involved in executing a computing task corresponding to the network layer and the device information corresponding to the plurality of computing devices; determining a target device corresponding to the network layer according to at least one of the computing time, data transmission time between a computing device corresponding to a previous network layer and other computing devices, memory space required by data of the network layer and remaining memory of each of the computing devices, and executing the computing task by the target device after receiving an execution request of the computing task corresponding to each of the network layers.

As can be seen from the above method, this solution can allocate different computing devices to different network layers based on the device information of different types of computing devices (CPU and GPU) to perform corresponding computing tasks. Compared with a current method of only performing main computing tasks through GPU, in this solution, both CPU and GPU can determine a matching network layer according to their device information, and then perform the computing task corresponding to this network layer, which greatly improves the utilization rate of different computing devices and further reduces the execution cost of computing tasks.

### BRIEF DESCRIPTION OF DRAWINGS

The accompanying drawings described herein are used to provide a further understanding of the present disclosure and constitute a part of the present disclosure. Illustrative embodiments of the present disclosure and their descriptions are used to explain the present disclosure and do not constitute improper limitations on the present disclosure. In the accompanying drawings:

FIG. 1 is a flowchart of a task execution method according to an embodiment of the present disclosure.

FIG. 2 is a schematic diagram of a task execution process during model training according to an embodiment of the present disclosure.

FIG. 3 is a schematic diagram of a task execution system according to an embodiment of the present disclosure.

FIG. 4 is a schematic diagram of a task execution apparatus according to an embodiment of the present disclosure.

FIG. 5 is a schematic diagram of an electronic device corresponding to FIG. 1 according to an embodiment of the present disclosure.

### DETAILED DESCRIPTION

In order to make the purposes, technical solutions and advantages of the present disclosure more clear, the technical solutions of the present disclosure will be described clearly and completely in the following in combination with specific embodiments of the present application and the corresponding accompanying drawings. Obviously, the described embodiments are only a part of the embodiments of the present disclosure, not the whole embodiments. Based on the embodiments in the present disclosure, all other embodiments obtained by those of ordinary skills in the art without making creative efforts belong to the protection scope of the present disclosure.

In a process of model training, a training process of each network layer of a model usually has a sequential relationship, and an input of a current network layer calculation depends on an output of a previous network layer calculation, so many GPUs spend most of their time waiting for a calculation of the previous network layer, resulting in vacancy of computing resources.

Pipeline parallelism is an approach to accelerate neural network training by combining model parallelism with data pipeline. Its core idea is to divide the model into several blocks according to layers, and each block is given to a device. In a forward transfer process, each device transfers an intermediate activation to a next stage. In a backward transfer process, each device returns a gradient of input tensors to a previous pipeline stage. This approach alleviates a waste of some resources in model parallelism.

However, at present, in a process of model parallel training, most computing tasks are completed by GPUs, and CPUs only perform data transmission and control, which leads to CPU resources has a low utilization rate and even being idle for most of the time, resulting in a waste of CPU resources.

Based on this, the present disclosure provides a task execution method, which determines an execution unit of a computing task corresponding to each network layer of a target model among execution units of different types of computing devices, so as to execute a computing task and improve a utilization rate of different types of computing resources.

In the present disclosure, an execution subject for executing the task execution method may refer to a designated device such as a server, a workstation, etc. For convenience of description, the present disclosure only takes the server(s) as the execution subject as an example to explain a task execution method provided by the present disclosure.

The technical solutions provided by various embodiments of the present application are described in detail below in conjunction with the accompanying drawings.

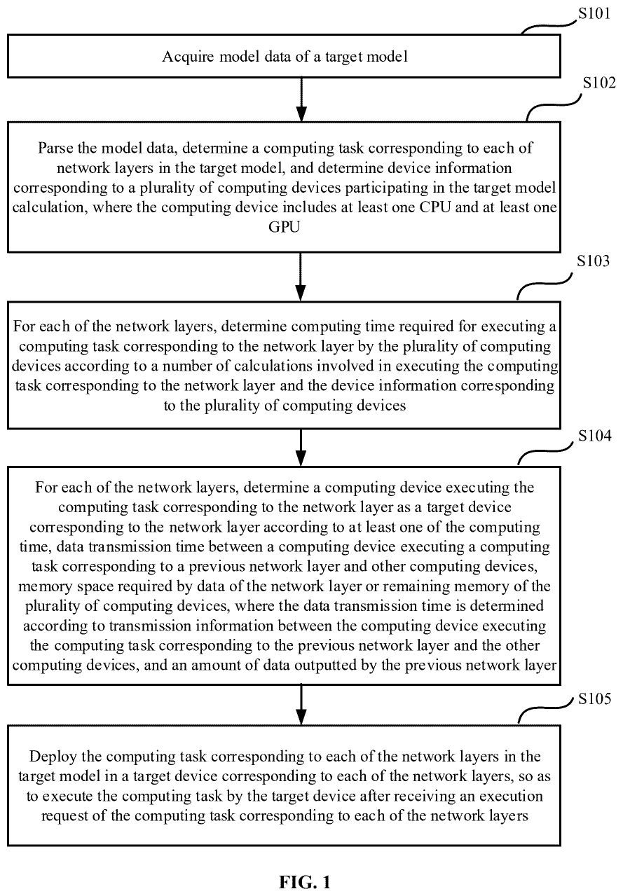

FIG. 1 is a flowchart of a task execution method according to the present disclosure, which includes the following steps.

At step S101: model data of a target model is acquired.

In a process of executing a computing task for the target model, server(s) need to acquire the model data of the target model. The computing task can be a computing task in a process of model training (including a computing task in a process of forward transfer and a computing task in a process of backward transfer). After acquiring a training request of the model, the server(s) can acquire the model data. Of course, the above computing task can also be a computing task of the model in a process of actual work.

At step S102: the model data is parsed, a computing task corresponding to each of network layers in the target model is determined, and device information corresponding to a plurality of computing devices participating in the target model calculation is determined, where the computing device includes at least one CPU and at least one GPU.

After acquiring the model data, the server(s) can parse the model data. For example, the server(s) can store a model structure in a form of a data flow diagram, and after parsing the model structure, the server(s) can determine the computing task corresponding to each network layer of the target model.

At the same time, the server(s) can determine the device information corresponding to each computing device, and each computing device can be deployed in a same terminal device (such as a computer), and of course, it can also be deployed in multiple nodes of a distributed computing system.

Each computing device refers to a computing device that plans to participate in a calculation of the target model. For example, before the target model is actually trained, the number of computing devices participating in the training can be determined.

In the present disclosure, the above computing device may include at least one CPU and at least one GPU, and of course, other processors such as a tensor processing unit (TPU) and an embedded neural-network processing unit (NPU) may also be included, which is not specifically limited in the present disclosure.

The device information of each computing device may include the number of CPUs, a frequency of CPU, a memory size of CPU, the number of GPUs, the number of GPU stream processors, a frequency of GPU stream processor, and a memory size of GPU, etc., where the memory size of CPU can refer to a size of memory available to the CPU on a motherboard, and the memory size of GPU can refer to a size of graphic memory of GPU, which is not specifically limited in the present disclosure.

In addition, the server(s) can further determine transmission information between computing devices, which includes a transmission mode between different computing devices and a bandwidth corresponding to different transmission modes. In the present disclosure, the above transmission mode may include at least one of a first transmission mode or a second transmission mode. The first transmission mode may include a peripheral component interconnect express (PCI-e), and the second transmission mode may include NVLINK, where NVLINK can be used for data transmission between GPUs.

The first transmission mode and the second transmission mode may further include other high-speed buses connecting CPU to GPU, and GPU to GPU. The present disclosure does not limit this. For simplicity, the following description takes PCI-e as the first transmission mode and NVLINK as the second transmission mode as an example.

Further, the server(s) may determine at least one execution unit contained in each computing device, obtain multiple execution units, and instantiate each execution unit. In the present disclosure, the execution unit can be determined according to the number of threads of the computing device, and of course, it can also be determined according to the number of cores of the computing device, which is not specifically limited in the present disclosure.

In some examples, in a GPU, an execution unit may include one or more GPUs, and in a CPU, an execution unit may include one or more CPUs and one or more CPU cores.

For each execution unit, the server(s) can determine computing power corresponding to the execution unit according to the device information of the computing device to which the execution unit belongs, which can be expressed as floating-point operations per second (FLOPS) corresponding to the execution unit.

At step S103: for each of the network layers, computing time required for executing a computing task corresponding to the network layer by the plurality of computing devices is determined according to a number of calculations involved in executing the computing task corresponding to the network layer and the device information corresponding to the plurality of computing devices.

At step S104: for each of the network layers, a computing device executing the computing task corresponding to the network layer is determined as a target device corresponding to the network layer according to at least one of the computing time, data transmission time between a computing device executing a computing task corresponding to a previous network layer and other computing devices, memory space required by data of the network layer or remaining memory of the plurality of computing devices, where the data transmission time is determined according to transmission information between the computing device executing the computing task corresponding to the previous network layer and the other computing devices, and an amount of data outputted by the previous network layer.

In the process of determining the computing device corresponding to each network layer, for each network layer, the server(s) derive the number of calculations (such as floating-point operations) and the amount of data output by the network layer, and determines the memory space required by the data (such as model parameters, tensors, etc.) of the network layer.

For an initial network layer of the target model, the server(s) can determine an execution unit corresponding to the initial network layer according to the number of calculations and memory space corresponding to the initial network layer, computing power corresponding to each execution unit and remaining memory of the computing device corresponding to each execution unit. The method of determining the execution unit can be expressed by the following formula (1):

$$Min ( \frac{{L}_{a} \cdot flop}{E {C}_{i}} ) , ∃ {Men}_{i} - {L}_{a} \cdot Mem > 0 \qquad ( 1 )$$

where Lₐ.flop is the number of calculations (floating-point operations) required by an initial network layer a, ECᵢ is computing power (floating-point operations per second) corresponding to an execution unit i, Menᵢ is remaining memory of a computing device corresponding to the execution unit i, Lₐ.Mem is memory space required by the network layer a.

In some examples, the initial network layer is a first layer at a beginning of a model. By using the above formula (1), it can be quickly determined on which execution unit the first layer performs the calculation.

In some examples, if the execution unit is the CPU, the remaining memory of the computing device corresponding to the execution unit i is memory of the device. If the execution unit is the GPU, the remaining memory of the computing device corresponding to the execution unit i is graphic memory of the GPU where the execution unit is located.

The server(s) can determine execution units with remaining memory larger than the memory space required by the initial network layer a according to the above formula, and take these execution units as candidate execution units. According to the number of calculations required by the initial network layer a and computing power corresponding to each candidate execution unit, computing time corresponding to each candidate execution unit is determined, and then, according to the computing time corresponding to each candidate execution unit, a unique execution unit corresponding to the network layer is determined (such as take a candidate execution unit with smallest computing time as an execution unit corresponding to the initial network layer a) as a target execution unit corresponding to the network layer.

For a network layer other than the initial network layer, the server(s) can determine an execution unit corresponding to the network layer according to the number of calculations and required memory space corresponding to the network layer, the computing power corresponding to each execution unit and the remaining memory of the computing device corresponding to each execution unit, the amount of data output by a previous network layer of the network layer, and transmission information between an execution unit corresponding to the previous network layer (that is, an execution unit executing a computing task corresponding to the previous network layer) and each execution unit. The method of determining the execution unit can be expressed by the following formula (2):

$$Min ( \frac{{L}_{a} \cdot flop}{E {C}_{i}} + \frac{{L}_{a - 1} \cdot size}{B {W}_{i , j , k}} ) , ∃ \frac{{L}_{a} \cdot flop}{E {C}_{i}} + \frac{{L}_{a - 1} \cdot size}{B {W}_{i , j , k}} < \frac{{L}_{a} \cdot flop}{E {C}_{j}} , a > 1 , {Men}_{i} - {L}_{a} \cdot Mem > 0 \qquad ( 2 )$$

where Lₐ₋₁.size is the amount of data output by the previous network layer, BW_{i,j,k} is a bandwidth between the execution unit j corresponding to the previous network layer and other execution unit i. When the execution unit j and the execution unit i belong to different computing devices, k has two values, which respectively represent two transmission modes, where k=0 indicates that PCI-e is used for the data transmission, and k=1 indicates that NVLINK is used for the data transmission. The execution unit j can also be called a reference execution unit. When the execution units i and j belong to the same computing device, BW_{i,j,k} is a maximum value, which aims to make transmission time tend to 0, at this time, the value of k is 0, which belongs to PCI-e data transmission mode.

Specifically, the server(s) can determine, based on the above formula, computing time corresponding to each execution unit according to the number of calculations corresponding to the network layer a (a>1) and the computing power corresponding to each execution unit, and determine data transmission time corresponding to each execution unit according to transmission information between a computing device corresponding to the previous network layer and each computing device, as well as the amount of data output by the previous network layer. Then the server(s) can determine comprehensive time corresponding to each execution unit according to the above computing time and data transmission time, that is,

$$\frac{{L}_{a} \cdot flop}{E {C}_{i}} + \frac{{L}_{a - 1} \cdot size}{{BW}_{i , j , k}} .$$

Further, in the process of determining the execution unit corresponding to the network layer a (a>1), the server(s) can determine among the execution units, as a candidate execution unit, an execution unit whose remaining memory of a corresponding computing device is larger than the required memory space of the network layer (a>1) and whose corresponding comprehensive time is less than required computing time when executing the computing task corresponding to the network layer by the execution unit of the previous network layer. Then, the server(s) can determine a target execution unit corresponding to the network layer according to comprehensive time corresponding to each candidate execution unit (such as take a candidate execution unit with the smallest comprehensive time as a computing unit corresponding to the network layer a).

It should be noted that in practical application, instead of dividing execution units corresponding to each computing device, it is also possible to determine computing devices corresponding to different network layers, each computing device may be equivalent to an execution unit, so as to perform the computing task corresponding to each network layer by the computing devices corresponding to different network layers.

In this process, for each non-initial network layer, the server(s) can determine computing time required for executing a computing task corresponding to the network layer by each computing device according to the number of calculations involved in executing the computing task corresponding to the network layer and device information corresponding to each computing device, and determine data transmission time corresponding to each computing device according to transmission information between a computing device corresponding to a previous network layer (that is, a computing device executing a computing task corresponding the previous network layer) and each computing device, as well as the amount of data output by the previous network layer. Then the server(s) can determine comprehensive time corresponding to each computing device according to the computing time and data transmission time corresponding to each computing device, and finally determine a computing device corresponding to the network layer as a target device corresponding to the network layer according to at least one of the comprehensive time corresponding to each computing device, remaining memory of each computing device or the above-mentioned memory space.

At step S105: the computing task corresponding to each of the network layers in the target model is deployed in a target device corresponding to each of the network layers, so as to execute the computing task by the target device after receiving an execution request of the computing task corresponding to each of the network layers.

Specifically, the server(s) can output a multi-tuple list based on the device information, transmission information and derived information, and the derived information can include the target device corresponding to each network layer, and can also include parameters such as the number of calculations and the amount of data output corresponding to each network layer. The list can include information such as which layer of a neural model network, forward and backward operation, a location in a computing device, whether to use direct memory access (DMA), whether to use NVLINK, etc. Then the server(s) can execute computing tasks by execution units corresponding to each network layer based on the multi-tuple list.

In the process of executing the computing tasks, the server(s) can first deploy the respective computing task corresponding to each network layer on a target device where the corresponding target execution unit is located. It should be noted that, for each network layer, if there are at least two transmission modes (e.g., including NVLINK and PCI-e) between a target execution unit corresponding to the network layer and a target execution unit corresponding to an adjacent network layer of the network layer, a transmission state of a current transmission mode is monitored, and determine whether the current transmission mode needs to be adjusted according to the monitored transmission state, where the above transmission state can include a busy level or traffic size of the current transmission mode, and if the current transmission mode is busy, the current transmission mode can be adjusted to another transmission mode.

In an example, considering types of buses supported by the CPU, NVLINK (second transmission mode) can be set only between GPU-related execution units, and NVLINK may not be set between CPU-related execution units and between a CPU-related execution unit and a GPU-related execution unit.

In some examples, the server(s) can determine transmission information (such as a bandwidth and a transmission mode) between execution units included in computing device(s) according to the transmission information between the computing devices, so as to determine transmission modes between multiple execution units and a bandwidth corresponding to each transmission mode.

In addition, in the present disclosure, for each network layer, if the target execution unit corresponding to the network layer and the target execution unit corresponding to the adjacent network layer are related to the GPU, and if there exists an NVLINK transmission mode between the target execution unit corresponding to the network layer and the target execution unit corresponding to the adjacent network layer, because the transmission efficiency of the NVLINK transmission mode is far more efficient than that of the PCI-e, the server(s) may preferentially choose to transmit data between the network layer and the adjacent network layer via the NVLINK transmission mode, and if not exists, choose to transmit via PCI-e.

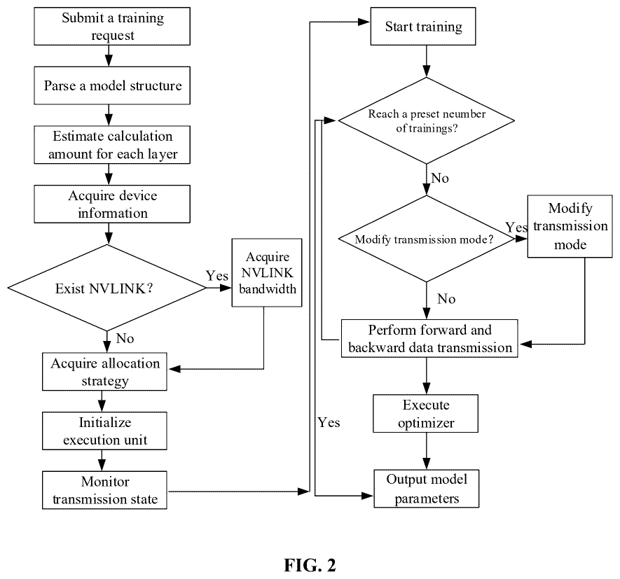

In the process of executing the computing tasks, when the transmission state of NVLINK is monitored to be busy, NVLINK can be adjusted to PCI-e. In the case of two transmission modes both exists, when the transmission state of PCI-e is relatively busy, PCI-e can also be adjusted to NVLINK to ensure the efficiency of executing the computing tasks. For ease of understanding, the present disclosure provides a schematic diagram of a task execution process during a model training, as shown in FIG. 2.

FIG. 2 is a schematic diagram of a task execution process during model training according to the present disclosure.

In a process of training a target model, a server can first acquire a training request submitted by a user, then parse a structure of a model, and determine a computing task corresponding to each network layer and a calculation amount (floating-point operation) corresponding to each network layer. At the same time, the server can acquire device information of each computing device, determine an execution unit corresponding to each computing device, and determine a transmission mode between execution units, such as whether there exists an NVLINK, and if exists, then determine a bandwidth thereof. Then the server can determine an allocation strategy based on the above device information, and prediction information and transmission information for each network layer.

After determining the allocation strategy, the server can initialize each execution unit, and monitor a transmission state after starting the training. If it is determined that the transmission mode needs to be modified, the transmission mode will be adjusted after meeting conditions. By performing forward and backward operations in the model training process by each target execution unit, and executing an optimizer, so as to output model parameters, the training of the target model will be stopped after reaching a preset epoch number of trainings.

The training flow in FIG. 2 is only an example of model training, which can be modified according to actual training situations. For example, whether the preset epoch number of trainings is reached can be changed to whether an objective function obtains an optimal solution, or whether a minimum value of a loss function is obtained, etc., which is not limited by the present disclosure.

In the present disclosure, a corresponding task execution system can also be deployed in the server(s) to complete the computing tasks through this task execution system. In order to facilitate understanding, the present disclosure provides a schematic diagram of the task execution system, as shown in FIG. 3.

FIG. 3 is a schematic diagram of a task execution system according to the present disclosure.

The task execution system includes an execution unit manager, a monitoring module and a dynamic resource scheduler, where the dynamic resource scheduler includes: a model analysis module, an allocation module, a judgment module and a configuration selection module. The execution unit manager includes execution units and transmission units corresponding to each computing device; and the monitoring module includes a function modification unit and a reallocation unit.

The execution unit manager is responsible for instantiating multiple execution units on various computing devices. For example, there may be one or more execution units on a GPU. These execution units are responsible for completing respective computing task corresponding to each network layer and providing input data for a next layer of a network. The transmission unit is responsible for a transmission of input data of the next layer. The number of transmission units and execution units is not consistent. If the next layer of the network and the execution unit are on different computing devices, a transmission unit will be instantiated. If the next layer of the network and a neural network layer responsible for the execution unit are on the same computing unit, there is no need to generate a transmission unit. The transmission unit is generated based on whether data transmission is required in an allocation solution, and the transmission mode of the transmission unit is also determined based on the allocation solution.

The monitoring module is responsible for monitoring the changes of node resources in each batch process of a deep neural network to calculate whether it is necessary to modify a data transmission mode between levels of the deep neural network. When the allocation solution is changed (that is, the execution unit (s) corresponding to each network layer is changed), the function modification unit of the monitoring module can modify the transmission mode of a corresponding transmission unit, and through such modification, a coincidence degree of data transmission and data calculation in the parallel process of the model can be dynamically adjusted to improve the efficiency of the deep neural network training.

As can be seen from the above method, this solution can allocate different computing devices to different network layers based on the device information of different types of computing devices (CPU and GPU) to perform corresponding computing tasks. Compared with a current method of only performing main computing tasks through GPU, in this solution, both CPU and GPU can determine a matching network layer according to their device information, and then perform the computing task corresponding to this network layer, which greatly improves the utilization rate of different computing devices and further reduces the execution cost of computing tasks.

In addition, this solution can further monitor a transmission state of a transmission mode between execution units, so as to adjust the transmission mode when a change condition is met, and ensure the efficiency of data communication during model training.

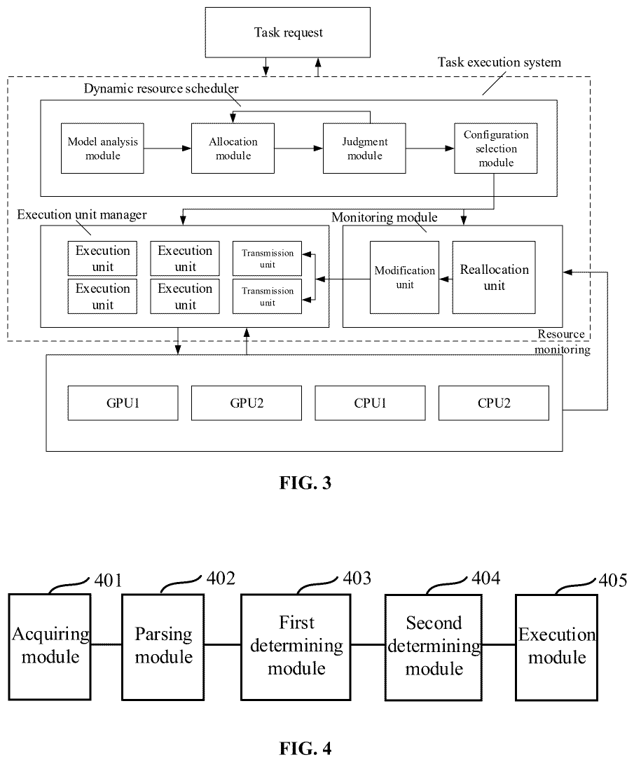

The above is one or more methods for implementing task execution in the present disclosure. Based on the same idea, the present disclosure further provides corresponding apparatuses for task execution, as shown in FIG. 4.

FIG. 4 is a schematic diagram of a task execution apparatus according to the present disclosure, including:
an acquiring module 401, configured to acquire model data of a target model;
a parsing module 402, configured to parse the model data, determine a computing task corresponding to each of network layers in the target model, and determine device information corresponding to a plurality of computing devices participating in a calculation of the target model, where the computing device includes at least one central processing unit (CPU) and at least one graphic processing unit (GPU);
a first determining module 403, configured to: for each of the network layers, determine computing time required for executing a computing task corresponding to the network layer by the plurality of computing devices according to a number of calculations involved in executing the computing task corresponding to the network layer and the device information corresponding to the plurality of computing devices;
a second determining module 404, configured to: for each of the network layers, determine a computing device executing the computing task corresponding to the network layer as a target device corresponding to the network layer according to at least one of the computing time, data transmission time between a computing device executing a computing task corresponding to a previous network layer and other computing devices, memory space required by data of the network layer or remaining memory of the plurality of computing devices, where the data transmission time is determined according to an amount of data outputted by the previous network layer and transmission information between the computing device executing the computing task corresponding to the previous network layer and the other computing devices; and
an execution module 405, configured to deploy the computing task corresponding to each of the network layers in the target model in a target device corresponding to each of the network layers, so as to execute the computing task by the target device after receiving an execution request of the computing task corresponding to each of the network layers.

In some examples, before determine the computing device corresponding to the network layer, the first determining module 403 is further configured to: determine at least one execution unit in each of the plurality of computing devices to obtain a plurality of execution units; and determine computing power corresponding to each of the plurality of execution units according to the device information corresponding to the plurality of computing devices.

In some examples, the first determining module 403 is specifically configured to: for each of the network layers, determine computing time required for executing the computing task corresponding to the network layer by each of the execution units according to the number of calculations involved in executing the computing task corresponding to the network layer and the computing power corresponding to each of the execution units.

In some examples, the second determining module 404 is specifically configured to: determine an execution unit executing the computing task corresponding to the network layer as a target execution unit corresponding to the network layer according to at least one of the computing time corresponding to each of the execution units, data transmission time between a reference execution unit and other execution units, the memory space or the remaining memory, where the reference execution unit includes an execution unit executing the computing task corresponding to the previous network layer; and where the deploy the computing task corresponding to each of the network layers in the target model in the target device corresponding to each of the network layers, so as to execute the computing task by the target device after receiving the execution request of the computing task corresponding to each of the network layers includes: deploy the computing task corresponding to each of the network layers in a target device where a target execution unit corresponding to each of the network layers is located, so as to execute the computing task by the target execution unit after receiving the execution request of the computing task corresponding to each of the network layers.

In some examples, the data transmission time is determined according to transmission information between the reference execution unit and other execution units and the amount of data outputted by the previous network layer.

In some examples, the second determining module 404 is specifically configured to, if the network layer is not an initial network layer of the target model, for each of the execution units, determine comprehensive time corresponding to the execution unit according to computing time corresponding to the execution unit and data transmission time corresponding to the execution unit; determine one or more candidate execution units among the plurality of execution units, where each of the candidate execution units is an execution unit where remaining memory of a corresponding computing device is larger than the memory space, and corresponding comprehensive time is less than required computing time when executing the computing task corresponding to the network layer by the reference execution unit; and determine the target execution unit corresponding to the network layer according to comprehensive time corresponding to each of the candidate execution units.

In some examples, the second determining module 404 is specifically configured to: determine one or more candidate execution units if the network layer is an initial network layer of the target mode; determine computing time corresponding to each of the candidate execution units according to the number of calculations involved in executing the computing task corresponding to the network layer and computing power corresponding to each of the candidate execution units; and determine the target execution unit corresponding to the network layer according to the computing time corresponding to each of the candidate execution units.

In some examples, the second determining module 404 is specifically configured to: determine one or more execution units with remaining memory larger than the memory space as the one or more candidate execution units.

In some examples, the execution module 405 is further configured to: for each of the network layers, if at least two transmission modes exist between the target execution unit corresponding to the network layer and a target execution unit corresponding to an adjacent network layer of the network layer, monitor a transmission state of a current transmission mode, determine whether the current transmission mode is to be adjusted according to the transmission state; and if the current transmission mode is to be adjusted, adjust the current transmission mode to another transmission mode.

In some examples, the execution module 405 is further configured to: determine transmission modes among the plurality of execution units and a bandwidth corresponding to each of the transmission modes, where the transmission mode includes: at least one of a first transmission mode or a second transmission mode.

In some examples, the execution module 405 is further configured to: if the target execution unit corresponding to the network layer and a target execution unit corresponding to an adjacent network layer are related to the GPU, and the second transmission mode exists between the target execution unit corresponding to the network layer and the target execution unit corresponding to the adjacent network layer, transmit data between the network layer and the adjacent network layer by the second transmission mode, otherwise, transmit the data between the network layer and the adjacent network layer by the first transmission mode.

In some examples, the first transmission mode includes a PCI-e, and the second transmission mode includes an NVLINK.

The present disclosure further provides a computer-readable storage medium, and the computer-readable storage medium stores a computer program, which can be used to execute a task execution method provided in FIG. 1.

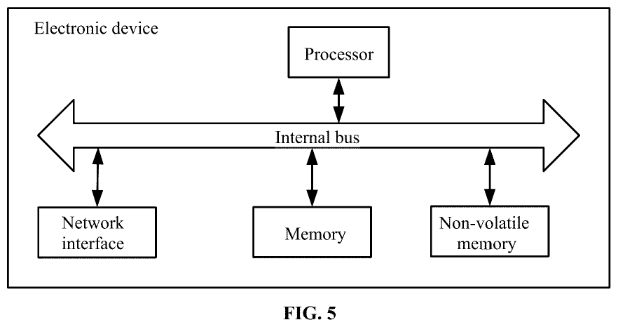

The present disclosure further provides a schematic structural diagram of an electronic device corresponding to FIG. 1 shown in FIG. 5. As shown in FIG. 5, at a hardware level, the electronic device includes a processor, an internal bus, a network interface, a memory and a non-volatile memory, and of course, it may further include hardware required by other services. The processor reads a corresponding computer program from the non-volatile memory into the memory and then runs it to realize the task execution method described in FIG. 1 above. Of course, besides a software implementation, the present disclosure does not exclude other implementations, such as logic components or the combination of software and hardware, etc., that is to say, an execution subject of the following processing is not limited to each logic unit, but also can be hardware or logic components.

An improvement of a technology can be clearly distinguished from an improvement of hardware (for example, an improvement of a circuit structure of diodes, transistors, switches, etc.) or an improvement of software (an improvement of a method flow). However, with the development of technology, the improvement of many method flows can be regarded as a direct improvement of hardware circuit structure. Designers almost always get a corresponding hardware circuit structure by programming an improved method flow into a hardware circuit. Therefore, it cannot be said that an improvement of a method flow cannot be realized by hardware entity modules. For example, programmable logic device (PLD) (for example, field programmable gate array (FPGA)) is such an integrated circuit, and its logic function is determined by user programming of components. Programmed by the designers to “integrate” a digital system on a PLD, without the need to ask a chip manufacturer to design and produce a special integrated circuit chip. Moreover, nowadays, instead of manually making integrated circuit chips, this programming is mostly changed to use “logic compiler” software, which is similar to a software compiler used in program development and writing, and an original code before compilation must be written in a specific programming language, which is called a hardware description language (HDL). There is not only one kind of HDL, but many kinds. Such as an advanced boolean expression language (ABEL), an altera hardware description language (AHDL), a Confluence, a Cornell University programming language (CupL), an HDCal, a java hardware description language (JHDL), a Lava, a Lola, a MyHDL, a PALASM, a ruby hardware description language (RHDL), etc. At present, a very-high-speed integrated circuit hardware description language (VHDL) and a Verilog are most commonly used. It should also be clear to those skilled in the art that hardware circuits implementing the logical method flow can be readily obtained by simply programming a method flow slightly with the above-mentioned hardware description language and programming into the integrated circuit.

A controller can be implemented in any suitable manner, for example, the controller may take a form of, for example, a microprocessor or processor and a computer-readable media storing computer-readable program code (e.g., software or firmware) that may be executed by a (micro) processor, a logic gate, a switch, an application specific integrated circuits (ASIC), a programmable logic controller, and an embedded microcontroller. Examples of controllers include, but are not limited to, the following microcontrollers: an ARC 625D, an Atmel AT91SAM, a Microchip PIC18F26K20, and a Silicone Labs C8051F320, and the controller may be implemented as part of the control logic of the memory. Those skilled in the art also know that, in addition to implementing the controller in the form of computer-readable program code, it is entirely possible to program the method steps logically to cause the controller to perform the same function in the form of logic gates, switches, special integrated circuits, programmable logic controllers, and embedded microcontrollers, etc. Therefore, this controller can be regarded as a hardware component, and an apparatus for realizing various functions included in it can also be regarded as a structure in the hardware component. Or even, the apparatus for realizing various functions can be regarded as both a software module for implementing the method and a structure in a hardware component.

The systems, apparatuses, modules or units illustrated in the above embodiments may specifically be realized by a computer chip or an entity, or by a product with a certain function. A typical implementation device is a computer. Specifically, the computer may, for example, be a personal computer, a laptop computer, a cellular telephone, a smartphone, a personal digital assistant, a media player, a navigation device, an e-mail device, a gaming console, a tablet computer, a wearable device, or a combination of any of these devices.

For the convenience of description, when describing the above apparatus, the functions are divided into various units and described separately. Of course, the functions of each unit can be implemented in the same or multiple software and/or hardware when the present disclosure is implemented.

It should be understood by those skilled in the art that embodiments of the present disclosure can be provided as a method, a system, or a computer program product. Therefore, the present disclosure can take the form of an entirely hardware embodiment, an entirely software embodiment, or an embodiment combining software and hardware aspects. Moreover, the present disclosure can take the form of a computer program product implemented on one or more computer-usable storage media (including but not limited to disk storage, CD-ROM, optical storage, etc.) containing computer-usable program codes.

The present disclosure is described with reference to flowcharts and/or block diagrams of methods, devices (systems), and computer program products according to the embodiments of the present disclosure. It should be understood that each flow and/or block in the flowcharts and/or block diagrams, and combinations of the flow and/or block in the flowcharts and/or block diagrams can be implemented by computer program instructions. These computer program instructions may be provided to a processor of a general-purpose computer, a special-purpose computer, an embedded processor or other programmable data processing device to produce a machine, such that instructions which are executed by a processor of the computer or other programmable data processing device produce an apparatus for implementing the functions specified in one or more flows of the flowcharts and/or one or more blocks of the block diagrams.

These computer program instructions may also be stored in a computer-readable memory that can direct a computer or other programmable data processing device to function in a particular manner, such that the instructions stored in the computer-readable memory produce an article of manufacture including an instruction apparatus that implements the functions specified in one or more flows of the flowcharts and/or one or more blocks of the block diagrams.

These computer program instructions may also be loaded onto a computer or other programmable data processing devices, such that a series of operational steps are performed on the computer or other programmable devices to produce a computer-implemented process, such that the instructions executed on the computer or other programmable devices provides steps for implementing the functions specified in one or more flows of the flowcharts and/or one or more blocks of the block diagrams.

In atypical configuration, a computing device includes one or more processors (CPUs), input/output interfaces, network interfaces, and memory.

The memory may include anon-permanent memory, a random access memory (RAM) in computer-readable media, and/or a non-volatile memory, such as a read-only memory (ROM) or a flash RAM. The memory is an example of a computer-readable medium.

The computer-readable media, including permanent and non-permanent, removable and non-removable media, can store information by any method or technology. Information can be computer-readable instructions, data structures, and modules of programs or other data. Examples of computer storage media include, but are not limited to, a phase change RAM (PRAM), a static random-access memory (SRAM), a dynamic random access memory (DRAM), DRAM), other types of random access memory (RAM), a read-only memory (ROM), an electrically erasable programmable read-only memory (EEPROM), a flash memory or other memory technologies, a compact disc read-only memory (CD-ROM), a digital video disc (DVD) or other optical storage, magnetic cassette, magnetic tape and disk storage or other magnetic storage devices or any other non-transmission media that can be used to store information that can be accessed by computing devices. As defined herein, computer-readable media does not include temporary computer-readable media, such as modulated data signals and carrier carriers.

It should also be noted that the terms “including”, “containing” or any other variations thereof are intended to cover non-exclusive inclusion, so that a process, method, commodity or device including a series of elements not only includes those elements, but also includes other elements not explicitly listed or elements inherent to such process, method, commodity or device. Without further limitations, an element defined by the phrase “including one” does not exclude the existence of other identical elements in the process, method, commodity or device including the element.

It should be understood by those skilled in the art that embodiments of the present disclosure can be provided as a method, a system, or a computer program product. Therefore, the present disclosure can take the form of an entirely hardware embodiment, an entirely software embodiment, or an embodiment combining software and hardware aspects. Moreover, the present disclosure can take the form of a computer program product implemented on one or more computer-usable storage media (including but not limited to disk storage, CD-ROM, optical storage, etc.) containing computer-usable program codes.

The present disclosure can be described in the general context of computer executable instructions executed by a computer, such as a program module. Generally, the program module includes a routine, a program, an object, a component, a data structure, etc. that performs particular tasks or implements particular abstract data types. The present disclosure may also be practiced in distributed computing environments where tasks are performed by remote processing devices that are connected via a communication network. In a distributed computing environment, the program module may be located in local and remote computer storage media including a storage device.

Each embodiment in the present disclosure is described in a progressive way, and the same and similar parts between the various embodiments can be referred to each other, and each embodiment focuses on the differences with other embodiments. Especially, for the system embodiment, because it is basically similar to the method embodiment, the description is relatively simple, and the relevant points can be found in part of the description of the method embodiment.

The above is only embodiments of the present disclosure and is not intended to limit the present disclosure. Various modifications and variations of the present disclosure will occur to those skilled in the art. Any modifications, equivalent substitutions, improvements, etc. made within the spirit and principle of the present disclosure should be included in the scope of the claims of the present disclosure.

1. A task execution method, comprising:
acquiring model data of a target model;
parsing the model data, determining a computing task corresponding to each of network layers in the target model, and determining device information corresponding to a plurality of computing devices participating in a calculation of the target model, wherein the computing device comprises at least one central processing unit (CPU) and at least one graphic processing unit (GPU);
for each of the network layers, determining computing time required for executing a computing task corresponding to the network layer by the plurality of computing devices according to a number of calculations involved in executing the computing task corresponding to the network layer and the device information corresponding to the plurality of computing devices;
for each of the network layers, determining a computing device executing the computing task corresponding to the network layer as a target device corresponding to the network layer according to at least one of the computing time, data transmission time between a computing device executing a computing task corresponding to a previous network layer and other computing devices, memory space required by data of the network layer or remaining memory of the plurality of computing devices, wherein the data transmission time is determined according to an amount of data outputted by the previous network layer and transmission information between the computing device executing the computing task corresponding to the previous network layer and the other computing devices; and
deploying the computing task corresponding to each of the network layers in the target model in a target device corresponding to each of the network layers, so as to execute the computing task by the target device after receiving an execution request of the computing task corresponding to each of the network layers.

2. The method according to claim 1, wherein before the determining the computing device executing the computing task corresponding to the network layer, the method further comprising:
determining at least one execution unit in each of the plurality of computing devices to obtain a plurality of execution units; and
determining computing power corresponding to each of the plurality of execution units according to the device information corresponding to the plurality of computing devices.

3. The method according to claim 2, wherein, for each of the network layers, determining the computing time required for executing the computing task corresponding to the network layer by the plurality of computing devices according to the number of calculations involved in executing the computing task corresponding to the network layer and the device information corresponding to the plurality of computing devices comprises:
for each of the network layers, determining computing time required for executing the computing task corresponding to the network layer by each of the execution units according to the number of calculations involved in executing the computing task corresponding to the network layer and the computing power corresponding to each of the execution units.

4. The method according to claim 3, wherein the determining the computing device executing the computing task corresponding to the network layer as the target device corresponding to the network layer according to at least one of the computing time, the data transmission time between the computing device executing the computing task corresponding to the previous network layer and the other computing devices, the memory space required by the data of the network layer or the remaining memory of the plurality of computing devices comprises:
determining an execution unit executing the computing task corresponding to the network layer as a target execution unit corresponding to the network layer according to at least one of the computing time corresponding to each of the execution units, data transmission time between a reference execution unit and other execution units, the memory space or the remaining memory, wherein the reference execution unit comprises an execution unit executing the computing task corresponding to the previous network layer; and
wherein the deploying the computing task corresponding to each of the network layers in the target model in the target device corresponding to each of the network layers, so as to execute the computing task by the target device after receiving the execution request of the computing task corresponding to each of the network layers comprises:
deploying the computing task corresponding to each of the network layers in a target device where a target execution unit corresponding to each of the network layers is located, so as to execute the computing task by the target execution unit after receiving the execution request of the computing task corresponding to each of the network layers.

5. The method according to claim 4, wherein the data transmission time is determined according to transmission information between the reference execution unit and other execution units and the amount of data outputted by the previous network layer.

6. The method according to claim 4, wherein the determining the execution unit executing the computing task corresponding to the network layer as the target execution unit corresponding to the network layer according to at least one of the computing time corresponding to each of the execution units, the data transmission time between the reference execution unit and the other execution units, the memory space or the remaining memory comprises:
in response to determining that the network layer is not an initial network layer of the target model, for each of the execution units, determining comprehensive time corresponding to the execution unit according to computing time corresponding to the execution unit and data transmission time corresponding to the execution unit;
determining one or more candidate execution units among the plurality of execution units, wherein each of the candidate execution units is an execution unit where remaining memory of a corresponding computing device is larger than the memory space, and corresponding comprehensive time is less than required computing time when executing the computing task corresponding to the network layer by the reference execution unit; and
determining the target execution unit corresponding to the network layer according to comprehensive time corresponding to each of the candidate execution units.

7. The method according to claim 4, wherein the determining the execution unit executing the computing task corresponding to the network layer as the target execution unit corresponding to the network layer according to at least one of the computing time corresponding to each of the execution units, the data transmission time between the reference execution unit and the other execution units, the memory space or the remaining memory comprises:
in response to determining that the network layer is an initial network layer of the target model, determining one or more candidate execution units;
determining computing time corresponding to each of the candidate execution units according to the number of calculations involved in executing the computing task corresponding to the network layer and computing power corresponding to each of the candidate execution units; and
determining the target execution unit corresponding to the network layer according to the computing time corresponding to each of the candidate execution units.

8. The method according to claim 7, wherein the determining the one or more candidate execution units comprises:
determining one or more execution units with remaining memory larger than the memory space as the one or more candidate execution units.

9. The method according to claim 4, further comprising:
for each of the network layers, in response to determining that at least two transmission modes exist between the target execution unit corresponding to the network layer and a target execution unit corresponding to an adjacent network layer of the network layer, monitoring a transmission state of a current transmission mode;
determining whether the current transmission mode is to be adjusted according to the transmission state; and
in response to determining that the current transmission mode is to be adjusted, adjusting the current transmission mode to another transmission mode.

10. The method according to claim 4, further comprising:
determining transmission modes among the plurality of execution units and a bandwidth corresponding to each of the transmission modes, wherein the transmission mode comprises: at least one of a first transmission mode or a second transmission mode.

11. The method according to claim 10, further comprising:
in response to determining that the target execution unit corresponding to the network layer and a target execution unit corresponding to an adjacent network layer are related to the GPU, and the second transmission mode exists between the target execution unit corresponding to the network layer and the target execution unit corresponding to the adjacent network layer, transmitting data between the network layer and the adjacent network layer by the second transmission mode, or
in response to determining that the target execution unit corresponding to the network layer and a target execution unit corresponding to an adjacent network layer are not related to the GPU, or the second transmission mode does not exist between the target execution unit corresponding to the network layer and the target execution unit corresponding to the adjacent network layer, transmitting the data between the network layer and the adjacent network layer by the first transmission mode.

12. The method according to claim 10, wherein the first transmission mode comprises a peripheral component interconnect express (PCI-e), and the second transmission mode comprises an NVLINK.

13. (canceled)

14. A non-transitory computer-readable storage medium, wherein the non-transitory computer-readable storage medium stores a computer program which, when executed by a processor, configured to:
acquire model data of a target model;
parse the model data, determine a computing task corresponding to each of network layers in the target model, and determine device information corresponding to a plurality of computing devices participating in a calculation of the target model, wherein the computing device comprises at least one central processing unit (CPU) and at least one graphic processing unit (GPU);
for each of the network layers, determine computing time required for executing a computing task corresponding to the network layer by the plurality of computing devices according to a number of calculations involved in executing the computing task corresponding to the network layer and the device information corresponding to the plurality of computing devices;
for each of the network layers, determine a computing device executing the computing task corresponding to the network layer as a target device corresponding to the network layer according to at least one of the computing time, data transmission time between a computing device executing a computing task corresponding to a previous network layer and other computing devices, memory space required by data of the network layer or remaining memory of the plurality of computing devices, wherein the data transmission time is determined according to an amount of data outputted by the previous network layer and transmission information between the computing device executing the computing task corresponding to the previous network layer and the other computing devices; and
deploy the computing task corresponding to each of the network layers in the target model in a target device corresponding to each of the network layers, so as to execute the computing task by the target device after receiving an execution request of the computing task corresponding to each of the network layers.

15. An electronic device, comprising a memory, a processor and a computer program stored in the memory and executable on the processor, wherein the processor, when executing the computer program, is configured to:
acquire model data of a target model;
parse the model data, determine a computing task corresponding to each of network layers in the target model, and determine device information corresponding to a plurality of computing devices participating in a calculation of the target model, wherein the computing device comprises at least one central processing unit (CPU) and at least one graphic processing unit (GPU);
for each of the network layers, determine computing time required for executing a computing task corresponding to the network layer by the plurality of computing devices according to a number of calculations involved in executing the computing task corresponding to the network layer and the device information corresponding to the plurality of computing devices;
for each of the network layers, determine a computing device executing the computing task corresponding to the network layer as a target device corresponding to the network layer according to at least one of the computing time, data transmission time between a computing device executing a computing task corresponding to a previous network layer and other computing devices, memory space required by data of the network layer or remaining memory of the plurality of computing devices, wherein the data transmission time is determined according to an amount of data outputted by the previous network layer and transmission information between the computing device executing the computing task corresponding to the previous network layer and the other computing devices; and
deploy the computing task corresponding to each of the network layers in the target model in a target device corresponding to each of the network layers, so as to execute the computing task by the target device after receiving an execution request of the computing task corresponding to each of the network layers.

16. The electronic device according to claim 15, wherein the processor is further configured to:
determine at least one execution unit in each of the plurality of computing devices to obtain a plurality of execution units; and
determine computing power corresponding to each of the plurality of execution units according to the device information corresponding to the plurality of computing devices.

17. The electronic device according to claim 16, wherein the processor is further configured to:
for each of the network layers, determine computing time required for executing the computing task corresponding to the network layer by each of the execution units according to the number of calculations involved in executing the computing task corresponding to the network layer and the computing power corresponding to each of the execution units.

18. The electronic device according to claim 17, wherein the processor is further configured to:
determine an execution unit executing the computing task corresponding to the network layer as a target execution unit corresponding to the network layer according to at least one of the computing time corresponding to each of the execution units, data transmission time between a reference execution unit and other execution units, the memory space or the remaining memory, wherein the reference execution unit comprises an execution unit executing the computing task corresponding to the previous network layer; and
wherein the deploy the computing task corresponding to each of the network layers in the target model in the target device corresponding to each of the network layers, so as to execute the computing task by the target device after receiving the execution request of the computing task corresponding to each of the network layers comprises:
deploy the computing task corresponding to each of the network layers in a target device where a target execution unit corresponding to each of the network layers is located, so as to execute the computing task by the target execution unit after receiving the execution request of the computing task corresponding to each of the network layers.

19. The electronic device according to claim 18, wherein the processor is further configured to:
in response to determining that the network layer is not an initial network layer of the target model, for each of the execution units, determine comprehensive time corresponding to the execution unit according to computing time corresponding to the execution unit and data transmission time corresponding to the execution unit;
determine one or more candidate execution units among the plurality of execution units, wherein each of the candidate execution units is an execution unit where remaining memory of a corresponding computing device is larger than the memory space, and corresponding comprehensive time is less than required computing time when executing the computing task corresponding to the network layer by the reference execution unit; and
determine the target execution unit corresponding to the network layer according to comprehensive time corresponding to each of the candidate execution units.

20. The electronic device according to claim 18, wherein the processor is further configured to:
in response to determining that the network layer is an initial network layer of the target model, determine one or more candidate execution units;
determine computing time corresponding to each of the candidate execution units according to the number of calculations involved in executing the computing task corresponding to the network layer and computing power corresponding to each of the candidate execution units; and
determine the target execution unit corresponding to the network layer according to the computing time corresponding to each of the candidate execution units.

21. The electronic device according to claim 18, wherein the processor is further configured to:
for each of the network layers, in response to determining that at least two transmission modes exist between the target execution unit corresponding to the network layer and a target execution unit corresponding to an adjacent network layer of the network layer, monitor a transmission state of a current transmission mode;
determine whether the current transmission mode is to be adjusted according to the transmission state; and
in response to determining that the current transmission mode is to be adjusted, adjust the current transmission mode to another transmission mode.
